(19) United States
(12) Patent Application Publication
(10) Pub. No.: US 2005/0202369 A1
(43) Pub. Date: Sep. 15, 2005

(54) Pontic assembly

(76) Inventor: Kwang H. Lee, Burbank, CA (US)

Correspondence Address: Jerry H. Noh, Suite 2741, 3435 Wilshire blvd, Los Angeles, CA, 90010, US

(21) Appl. No.: 10/800,375

(22) Filed: Mar. 12, 2004

(51) Int. Cl. A61C 13/12

(52) U.S. Cl. 433/180

(57) ABSTRACT

An improved pontic and pontic assembly utilized in the investment process in the making of investment mold castings for frameworks for dental prosthesis including dental bridges and method of manufacturing frameworks casting for dental prosthesis including dental bridges. The pontic assembly comprising a pair of wax copings having a space therebetween formed from a stone model of an area of a patient's teeth including a pair of abutment teeth. A wax coated enforcement bar connecting the pair of wax copings, and prefabricated wax structures connecting to the enforcement bar. The enforcement bar being spirally threaded.

### BACKGROUND OF THE INVENTION

1. Field of the Invention

This invention relates to a device for manufacturing dental prosthesis, more particularly, this invention relates to an improved pontic and pontic assembly in the making of investment mold castings for dental prosthesis.

2. Description of the Prior Art

The casting of miscellaneous items by both jewelry and dental technicians utilize the lost wax process. For dental technicians, the lost wax process is used for several dental restoration procedures including crown restorations, inlays, bridges, and coping. For a typical dental bridge restoration, an impression of a predetermined area of the patient's teeth is taken by a doctor, and a model of the area of teeth is made from the impression. The model commonly has a pair of protruding abutment teeth and a gap therebetween resulting from the space created by one or more missing tooth. Layers of wax are built-up onto each abutment tooth to an exact replication of the crown or the substructure, which are referred to as copings. One or more pontics corresponding to the number of missing teeth between the abutment teeth is connected between the copings formed on each abutment tooth to form a pontic assembly. The finished pontic assembly is connected by sprues to a runner bar, removed from the stone model, and placed in a casting ring for investment. The casting ring is then filled with investment material which solidifies. The solidified investment material is removed from the casting ring and base unit and heated to burn out any non-metal material such as the copings, runner bar, sprues, and pontic. Thereafter, a metal (precious or non-precious) is melted down and cast into the void created by the burned out structures. After the metal is cooled, the investment material is removed to expose the cast structure, which is the framework for the dental bridge. The cast structure is then placed onto the stone model to determine the fit of the cast structure thereon. The cast structure must have an accurate fit onto the stone model. If the fit is not accurate, the cast structure must be adjusted or the entire pontic assembly, investment, and casting process repeated to form a new cast structure. Adjusting the cast structure can be time consuming in that it can require that the cast structure be cut and soldered. A common cause of the inaccurate fit is the use of a bar made of wax as a pontic for horizontal connection of the bar between the copings. Such wax bars are connected to each coping with the application of wax. There can be the potential for movement of the wax bar and copings by expansion or shrinkage created by the heating or cooling during the waxing and investing processes.

Another problem arises in the fabrication of wax mold onto the pontic. Currently dental technicians spend a relatively considerable amount of time building up the bar portion of the pontic with a wax mold which corresponds to a missing tooth. There are prefabricated pontics such as U.S. Pat. Nos. 4,269,595 and 4,346,750 issued to Nemethy; however, dental technicians still must spend time in adjusting the sizes, angles, and positions of the pontic to make it fit accordingly on the stone model.

Thus, it is an object of the present invention to provide a pontic assembly which produces a precisely fitting bridge cast structure after casting. It is another object of the present invention to provide a pontic assembly, which provides quick and adjustable fabrication. Another object of the present invention is to provide a pontic assembly having stronger pontic connections and which can reduce the usage of precious metals in the case of casting bridges with precious metals such as gold. It is yet another object of the present invention to provide a prefabricated pontic for use in a pontic assembly.

### SUMMARY OF THE INVENTION

The present invention is an improved pontic and pontic assembly utilized in the investment mold process for the making of frameworks for dental prosthesis including dental bridges. The prefabricated pontic of the present invention is shown in FIG. 4, and the pontic assembly of the present invention is illustrated in FIGS. 1, 5, and 6. The pontic assembly formed from a stone model of an area of a patient's teeth. The stone model includes a pair of abutment teeth having a space therebetween. Layers of wax are built onto each abutment teeth of the stone model to form wax copings. FIG. 1 shows two wax structures formed between the wax copings to correspond to two missing teeth between the abutment teeth. An enforcement bar is sized to connect between the two wax copings, and the wax structures are formed onto the enforcement bar. The enforcement bar is dipped in wax to form a coating of wax thereon. Each of the wax structures on the enforcement bar can be formed thereon by build up of a wax mold to correspond to each missing tooth or by attachment of the prefabricated wax pontic as shown in FIG. 4. Sprues having an end connected to a runner bar and an opposing end connected to the corresponding wax structure and copings can be used to remove the pontic assembly from the stone model.

The enforcement bar can be made of a plastic material or a material which will not melt during the burn-out stage of the casting process such as dental metal. The enforcement bar has spiral threading formed throughout the length of the bar and can be made in several different predetermined sizes and diameters. Additionally, the enforcement bars are elongated and can be straight or have different predetermined degrees of curvature. In a pontic assembly of the present invention having a enforcement bar made of a dental metal, it is preferred that the pontic assembly further include a bar holder formed to attach to the enforcement bar. The bar holder in the embodiment shown is made of a dental metal and has a clamp portion for gripping and locking onto the enforcement bar.

### BRIEF DESCRIPTION OF THE DRAWINGS

FIG. 1 is a perspective view of a multi-unit wax structure pontic assembly removed from the stone model formed from the dental impression;

FIG. 1a is an enlarged view of the lingual side of a portion of the pontic assembly;

FIG. 2 is an isolated perspective view of the enforcement bar of the present invention;

FIG. 2a is an enlarged view of a portion of the enforcement bar;

FIG. 3 is a perspective isolated view of an enforcement bar and a bar holder;

FIG. 3a is an enlarged isolated view of the bar holder;

FIG. 4 is an isolated view of a pair of prefabricated wax pontics;

FIG. 5 is a top cross-sectional view of the pontic assembly invested in a casting ring; and,

FIG. 6 is a side cross-sectional view showing the lingual side of the pontic assembly which is invested in a casting ring.

### DETAILED DESCRIPTION OF THE PREFERRED EMBODIMENT

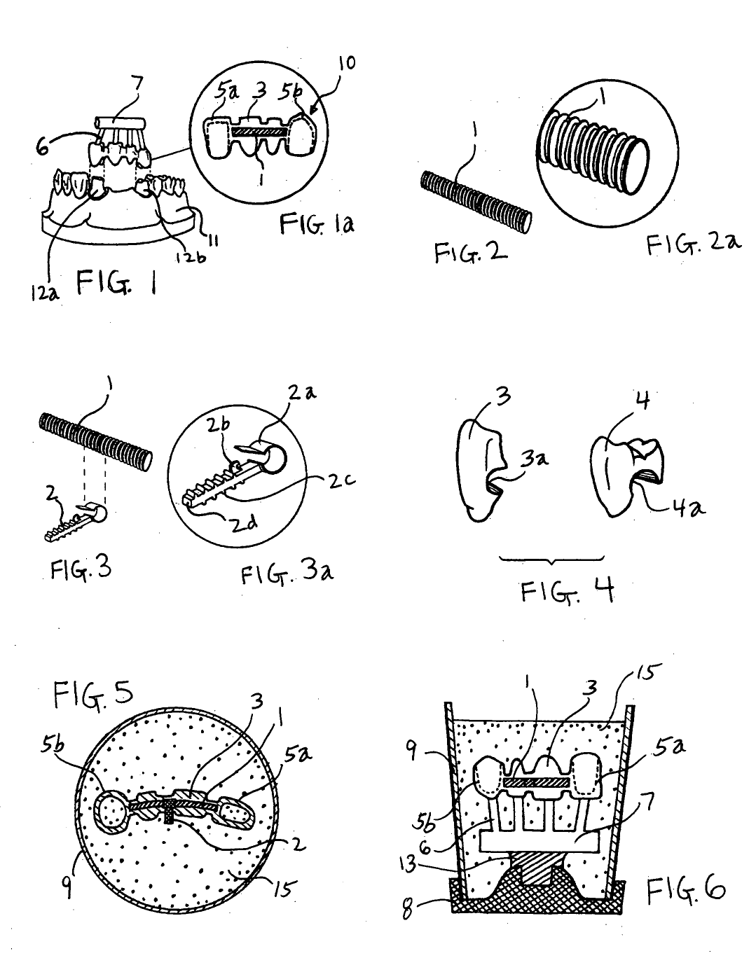

The present invention illustrated in FIGS. 1 to 6 is a prefabricated pontic 3, 4 and pontic assembly 10 for the manufacture of frameworks for dental bridges. FIG. 1 shows a stone model 11 formed from an impression of an area of a patient's teeth which includes a pair of abutment teeth 12a and 12b which has been ground down by a doctor for the restoration of the corresponding teeth and the missing teeth between the abutment teeth 12a, 12b. In the embodiment shown, the abutment teeth 12a, 12b has two missing teeth in the space between the abutment teeth 12a, 12b. Layers of wax are built onto each abutment teeth 12a, 12b of the stone model 11 to form wax copings 5a, 5b. FIG. 1 shows two wax structures formed between the wax copings 5a, 5b. The two wax structures are formed onto an enforcement bar 1 which is sized to fit between the wax copings 5a, 5b as shown in FIG. 1a. The enforcement bar 1 is dipped in wax to form a coating of wax thereon. Each end of the enforcement bar 1 connects to a corresponding wax coping 5a, 5b by melted wax hardened at the connection area. Each of the wax structures on the enforcement bar 1 can be formed thereon by build up of a wax mold to correspond to each missing tooth or by attachment of a prefabricated wax pontic 3, 4 as shown in FIG. 4. Each prefabricated wax pontic 3, 4 is a substructure formed to replicate the missing teeth and has a connection groove 3a, 4a formed on the lingual side or bottom depending on the type of tooth being replicated. The wax pontic 3, 4 of the present invention is of a predetermined size and shape according to any one of the different types of tooth of a patient. FIG. 4 illustrates a wax pontic 3 prefabricated in the shape of an anterior tooth with a groove 3a formed in the lingual side thereof and another wax pontic 4 prefabricated in the shaped of a posterior tooth with a groove 4a formed near the bottom thereof. The grooves 3a, 4a are sized and shaped for quick and secure connection onto the enforcement bar 1. Sprues 6 having an end connected to a runner bar and an opposing end connected to a corresponding wax structure and copings 5a, 5b can be used to remove the pontic assembly 10 from the stone model.

The enforcement bar 1 as shown in FIGS. 1a, 2, and 2a can be made of a plastic material or a material which will not melt during the burn-out stage of the casting process. The material which will not melt during the burn-out stage of the casting process is a dental metal of a precious, non-precious, or semi-precious value. As shown in FIG. 2a, the enforcement bar 1 has spiral threading la formed throughout the length of the bar 1. The enforcement bars 1 are made in several different predetermined sizes and diameters. Also, the enforcement bars 1 are elongated and can be straight or have different predetermined degrees of curvature. Gold is a well known precious dental metal and can be used for the enforcement bar; however, gold is not a preferred metal for the enforcement bar since gold is known to be malleable and weaker than non-precious and semi-precious metals.

FIG. 3 and 3a shows a bar holder 2 which is formed to attach to the enforcement bar 1. The bar holder 2 is made of a dental metal and has a clamp portion 2a for gripping and locking onto the enforcement bar 1. The enforcement bar 1 is a suggested item for use with enforcement bars 1 made of metal and not for use with enforcement bars 1 made of plastic. The bar holder 2 is attached to the enforcement bar 1 before the investment process and serves to hold the metal enforcement bar 1 in the proper position in the investment mold during the casting process after the wax structures are burned out. The bar holder 2 as shown has ridges 2c formed thereon for secure engagement with the investment material during the investment process. The bar holder 2 will still be locked onto the enforcement bar 1 throughout and after the casting process and will be cut-off the enforcement bar 1 in forming the casted framework for the dental bridge.

FIG. 5 shows the pontic assembly mounted by sprues 6 onto a runner bar 7 attached to the base unit 8 of a casting ring 9. The pontic assembly 10 is placed into a casting ring 9 for investment by pouring a liquid investment material 15 into and filling the casting ring 9. Then the liquid investment material 15 is allowed to harden, and this process of hardening generates heat change. This hardening process is one of the situations in which structures on the pontic assembly and sprues made of wax can expand and contract as a result of the heat change, but the stability of the enforcement bar 1 of the present invention which is unaffected by the temperature change of the present process prevents any such movement of the pontic assembly or sprues. After the investment material is set rigidly, the base unit 8 and casting ring 9 is removed, and the investment mold is put into an oven for casting by first undergoing a burn-out stage in which all non-metal structure will burn away leaving a void in the investment mold where the runner bar 7, sprues 6, and non-metal parts of the pontic assembly 10 used to be. Thereafter, the void is filled by casting a molten metal into the investment mold. The result after removing the investment material is the casted framework of the dental bridge. For a dental bridge having a framework made of precious metal, the enforcement bar 1 made of a semi-precious or non-precious metal should be used along with the bar holder 2. Use of the metal enforcement bar 1 is ideal in that it reduces the amount of precious metal used in the casting of the framework because the enforcement bar 1 takes up part of the space of the framework which would otherwise have been made of precious metal. Also, the wax coating on the enforcement bar 1 which is burned out during the casting leaves enough space in the voided investment mold to allow the enforcement bar 1 to be covered with a layer of precious metal during casting so that the resulting framework will appear to have the appearance of being made entirely of the precious metal. The resulting framework will however be stronger than a framework made entirely of only precious metal in that the enforcement bar 1 is of greater strength and rigidity than that made entirely of precious metal.

Although embodiments of the invention have been described and illustrated for purposes of clarity and example, it should be understood that many changes, substitutions and modifications to the described embodiment will be apparent to those having skill in the art in light of the foregoing disclosure without departing from the scope and spirit of the present invention which is defined by the claims which follow.

1. A pontic assembly for the manufacture of dental bridges, said assembly comprising:
a pair of copings defining a space therebetween; and an enforcement bar connecting said copings.

2. The pontic assembly as described in claim 1 wherein said enforcement bar is covered with wax.

3. The pontic assembly as described in claim 1 wherein said enforcement bar is made of plastic.

4. The pontic assembly as described in claim 1 wherein said enforcement bar is made of metal.

5. The pontic assembly as described in claim 4 further comprising a bar holder attached to said enforcement bar; said bar holder being made of a material which will not melt during burn-out stage of the casting process; said bar holder having a clamp portion for gripping onto said enforcement bar.

6. The pontic assembly as described in claim 1 further comprising at least one prefabricated pontic having a groove formed thereon for attachment to said enforcement bar.

7. The pontic assembly as described in claim 1 wherein said enforcement bar is threaded.

8. The pontic assembly as described in claim 7 wherein said enforcement bar is spirally threaded.

9. A pontic assembly for the manufacture of dental bridges, said assembly comprising:
a pair of wax copings formed from a model of an area of a person's teeth including a pair of abutment teeth; said copings defining a space therebetween; an enforcement bar connecting said copings;
said enforcement bar covered with wax;
at least one prefabricated pontic having a groove formed thereon, said pontic attached at said groove to said enforcement bar.

10. The pontic assembly as described in claim 9 wherein said enforcement bar is made of plastic.

11. The pontic assembly as described in claim 9 wherein said enforcement bar is made of metal.

12. The pontic assembly as described in claim 11 further comprising a bar holder attached to said enforcement bar; said bar holder being made of a material which will not melt during the burn-out stage of the casting process; said bar holder having a clamp portion for gripping onto said enforcement bar.

13. The pontic assembly as described in claim 9 wherein said enforcement bar is threaded.

14. The pontic assembly as described in claim 13 wherein said enforcement bar is spirally threaded.

15. An enforcement bar for use in a pontic assembly for the manufacture of dental bridges, said pontic assembly having a pair of wax copings formed from a model of an area of a person's teeth including a pair of abutment teeth, said wax copings defining a space therebetween, said enforcement bar comprising:
spiral threading disposed throughout the surface of said enforcement bar; and,
said enforcement bar having a predetermined size and shape for connecting said copings.

16. The enforcement bar as described in claim 15 wherein said enforcement bar further comprises at least one prefabricated pontic having a groove formed thereon, said pontic attached at said groove to said enforcement bar.

17. The enforcement bar as described in claim 15 wherein said enforcement bar is covered with at least a layer of wax.

18. The enforcement bar as described in claim 15 wherein said enforcement bar is made of plastic.

19. The enforcement bar as described in claim 15 wherein said enforcement bar is made of metal.

20. The enforcement bar as described in claim 19 further comprising a bar holder attached to said enforcement bar; said bar holder being made of a material which will not melt during the burn-out stage of the casting process; said bar holder having a clamp portion for gripping onto said enforcement bar.

21. A wax pontic used in the formation of a pontic assembly for the manufacture of dental bridges, said pontic assembly having a pair of wax copings formed from a model of an area of a person's teeth including a pair of abutment teeth, said wax copings defining a space therebetween and connected by an enforcement bar, said pontic comprising:
a groove formed thereon sized and shaped for connection of said pontic at said groove onto said enforcement bar;
said pontic having a predetermined size and shape of a tooth.

22. A method of making a pontic assembly for the making of dental bridges comprising the steps of:
providing a model of an area of a person's teeth including a pair of abutment teeth;
layering said pair of abutment teeth with wax to form a pair of wax copings;
providing a threaded, wax coated enforcement bar;
connecting each end of said enforcement bar to a corresponding wax coping;
removing said pontic assembly from said model;
investing said pontic assembly; and,
casting said pontic assembly.

23. In the method of claim 22:
providing at least one prefabricated wax pontic having a groove formed thereon; and,
attaching said wax pontic at said groove onto said enforcement bar prior to investing said pontic framework.

24. In the method of claim 22:
providing a threaded, wax coated enforcement bar made of a metal;
providing a bar holder made of a material which will not melt during the burn-out stage of the casting process;
attaching said bar holder onto said enforcement bar prior to investing said pontic framework.
